(19) United States
(12) Patent Application Publication
(10) Pub. No.: US 2004/0089060 A1
(43) Pub. Date: May 13, 2004

(54) Fault detection system and method

(75) Inventor: Yusuke Suzuki, Susono-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/682,825

(22) Filed: Oct. 10, 2003

(30) Foreign Application Priority Data
Nov. 13, 2002 (JP) 2002-329744

(51) Int. Cl. G01M 19/00

(52) U.S. Cl. 73/118.1

(57) ABSTRACT

A fault detection system for detecting a fault in a sensor based on a resistance of a sensor element includes a detector that detects the resistance of the sensor element, and a heating device that heats the sensor element. A controller of the system calculates an accumulated value of energization time of the heating device or an accumulated value of a characteristic value corresponding to the energization time of the heating device, and detects a fault in the sensor based on the resistance of the sensor element and the accumulated value.

The disclosure of Japanese Patent Application No. 2002-329744 filed on Nov. 13, 2002, including the specification, drawings and abstract, is incorporated herein by reference in its entirety.

### BACKGROUND OF THE INVENTION

1. Field of the Invention

The invention relates to fault detection system and method, and, more particularly, to fault detection system and method for detecting a fault in a sensor element that is heated to be set to an appropriate temperature.

2. Description of Related Art

There is known a method of detecting a fault or an abnormality in an exhaust gas sensor, or the like, by detecting the resistance of a sensor element of the sensor, and detecting a fault based on the resistance of the sensor element. The exhaust gas sensor, or the like, is heated by a heater after it is started. In the fault detecting method, therefore, the resistance of the sensor element needs to be detected in a condition in which the sensor has been sufficiently heated to an appropriate operating temperature.

To meet the above requirement, Japanese Laid-open Patent Publication No. 8-271475 (JP-A-8-271475) discloses a method of determining a heated condition of the sensor by calculating an accumulated value of electric power supplied to the heater. In this method, when the accumulated value of the heater power becomes equal to or larger than a predetermined value after a start of the sensor, it is determined that the sensor is heated by a certain degree.

If the resistance of the sensor element is within a predetermined range when the accumulated value of the heater power has reached the predetermined value, namely, when it is determined that the sensor has been heated by a certain degree, it is determined that the sensor is normal, namely, the sensor operates normally. If the resistance of the sensor element is outside the predetermined range in this condition, it is determined that the sensor element has deteriorated to such an extent that varies or affects a correlation between the resistance of the sensor element and the element temperature, or that the heater has an abnormal heating function.

In the method as disclosed in the above-identified publication, however, calculation of the heater power is required for determining the heated condition of the sensor. In order to calculate the heater power, it is necessary to detect a voltage applied to heater terminals and a current that flows through the heater. Thus, a circuit needs to be separately provided for detecting the voltage and the current. Also, the detection of the voltage and the current undesirably makes a control algorithm complicated.

Furthermore, since the heater power needs to be calculated from the detected voltage value and current value, a circuit and arithmetic computation are separately required for calculating the heater power, resulting in increased complexity in a control circuit of the system and the control algorithm.

### SUMMARY OF THE INVENTION

It is therefore an object of the invention to provide a fault detection system that operates with a minimized circuit arrangement and simplified control algorithms. It is another object of the invention to provide a fault detecting method that is implemented with a minimized circuit arrangement and simplified control algorithms.

To accomplish the above and/or other object(s), there is provided according to one aspect of the invention a fault detection system for detecting a fault in a sensor based on a resistance of a sensor element, which includes (a) a detector that detects the resistance of the sensor element, (b) a heating device that heats the sensor element, and (c) a controller that calculates an accumulated value of energization time of the heating device or an accumulated value of a characteristic value corresponding to the energization time of the heating device, and detects a fault in the sensor based on the resistance of the sensor element and the accumulated value.

In the fault detection system as described above, the temperature of the sensor element can be estimated from the accumulated value, without using a complicated logic, and a fault detection can be performed based on the resistance of the sensor element that is correlated with the element temperature.

In one preferred embodiment of the invention, the controller acquires a duty value representing the energization time of the heating device, as the characteristic value, and calculates the accumulated value of the duty value. With this arrangement, the temperature of the sensor element can be estimated with a simple logic by accumulating the duty value as a command signal to the heating device.

In another preferred embodiment of the invention, the controller compares the accumulated value with a predetermined value, and determines whether the sensor is faulty based on the resistance of the sensor element when the accumulated value becomes equal to or larger than the predetermined value.

According to the embodiment as described above, the resistance of the sensor element obtained when the accumulated value becomes equal to or larger than the predetermined value is used for determining whether the sensor is normal or faulty. Thus, a fault or abnormality in the sensor can be detected based on the resistance of the sensor element in a condition in which the sensor element has been sufficiently heated.

In a further preferred embodiment of the invention, the controller determines whether the sensor element or the heating device is faulty, based on the resistance of the sensor element and the accumulated value. Thus, a fault or abnormality in the sensor element or the heating device can be detected based on the accumulated value and the element resistance value.

### BRIEF DESCRIPTION OF THE DRAWINGS

The foregoing and/or further objects, features and advantages of the invention will become more apparent from the following description of an exemplary embodiment with reference to the accompanying drawings, in which like numerals are used to represent like elements and wherein:

FIG. 1 is a view showing a fault detection system according to one embodiment of the invention and a structure surrounding the fault detection system;

FIG. 2 is a schematic cross-sectional view showing the construction of a NOx sensor to which the fault detection system of the embodiment of FIG. 1 is applied;

FIG. 3 is a diagram illustrating some examples of heater control duty determined by an ECU; and

FIG. 4 is a flowchart illustrating a control routine executed by the fault detection system according to the embodiment of FIG. 1.

### DETAILED DESCRIPTION OF EXEMPLARY EMBODIMENT

An exemplary embodiment of the invention will be described with reference to the drawings. It is to be understood that the invention is not limited to details of this embodiment.

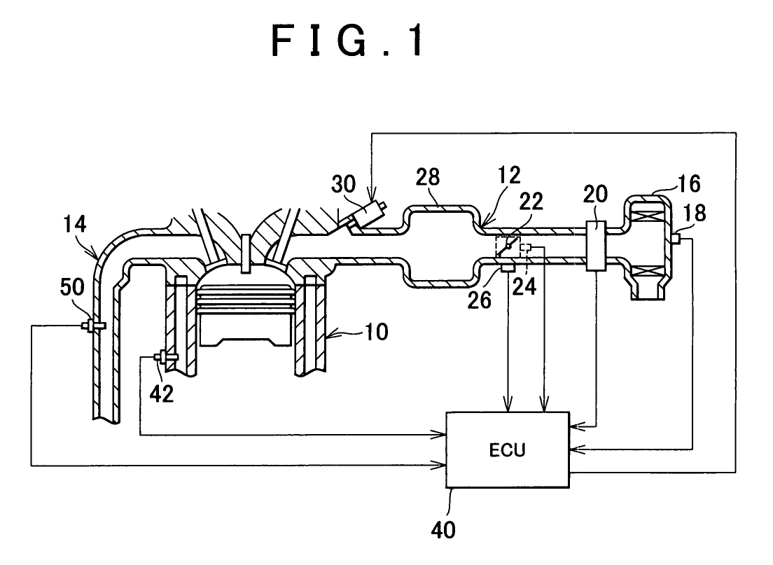

FIG. 1 shows a fault detection system according to one embodiment of the invention and a structure surrounding the fault detection system. In the present embodiment, the fault detection system is adapted to detect a fault or an abnormality in, for example, a NOx sensor for measuring NOx contained in exhaust gases. As shown in FIG. 1, an internal combustion engine 10 communicates with an intake passage 12 and an exhaust passage 14. An air filter 16 is provided in an upstream end portion of the intake passage 12. To the air filter 16 is mounted an intake air temperature sensor 18 for sensing the intake air temperature THA (i.e., the temperature of the outside air).

In the intake passage 12, an air flow meter 20 for measuring the mass flow or flow rate Ga of the air flowing through the intake passage 12 is disposed downstream of the air filter 16, and a throttle valve 22 is disposed downstream of the air flow meter 20. In the vicinity of the throttle valve 22 are disposed a throttle sensor 24 for sensing the throttle opening TA, and an idle switch 26 that is turned on when the throttle valve 22 is fully closed. A surge tank 28 is provided downstream of the throttle valve 22, and a fuel injector 30 for injecting fuel into an intake port of the engine 1 is disposed downstream of the surge tank 28.

A NOx sensor 50 is mounted in the exhaust passage 14. The NOx sensor 50 is adapted to detect the concentration of nitrogen oxides (NOx) in exhaust gas emitted from the internal combustion engine 10, and send an output signal indicative of the NOx concentration to an ECU (Electronic Control Unit) 40. The ECU 40 changes operating conditions of the engine 10 based on the output value (indicative of the NOx concentration) received from the NOx sensor 50, so that the engine 10 is brought into a desired operating state. The above-mentioned sensors, the fuel injector 30, a water temperature sensor 42 for sensing the coolant temperature THW of the engine 10, and other sensors and actuators are connected to the ECU 40.

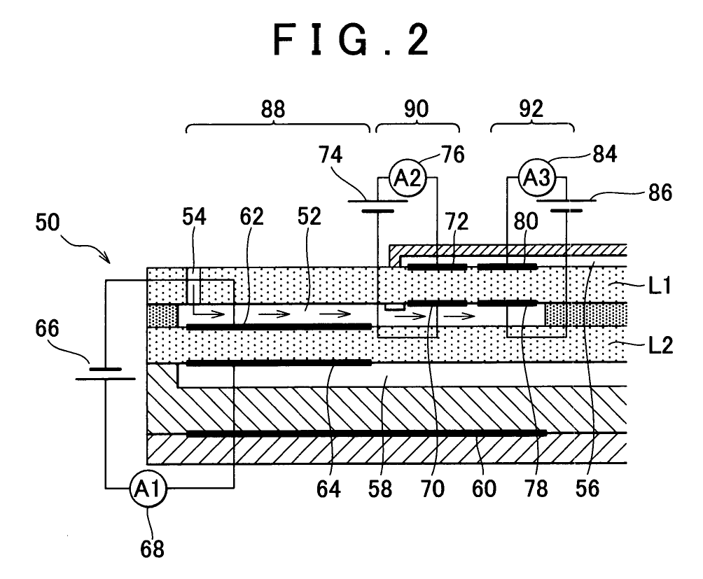

Referring next to FIG. 2, the construction of the NOx sensor 50 will be described. FIG. 2 is a schematic cross-sectional view showing the construction of the NOx sensor 50. As shown in FIG. 2, a sensor portion of the NOx sensor 50 includes oxygen-ion-conductive solid electrolyte layers that are formed of, e.g., zirconium oxide (or zirconia) and are laminated on each other, and the laminated solid electrolyte layers consist of a first layer L1 as the upper layer and a second layer L2 as the lower layer.

A cell chamber 52 is formed between the first layer L1 and the second layer L2. The first layer L1 is formed with an opening 54 through which the exhaust gas is introduced into the cell chamber 52. In operation, the exhaust gas, which is drawn into the cell chamber 52 through the opening 54, flows in the direction of arrows in FIG. 2 so that the cell chamber 52 is filled with the exhaust gas.

An atmosphere chamber 56 that communicates with the outside air is formed above the first layer L1. In addition, an atmosphere chamber 58 that communicates with the outside air is formed below the second layer L2.

A cathode-side pump electrode 62 is provided on an inner circumferential surface of the second layer L2 that faces the cell chamber 52. Also, an anode-side pump electrode 64 is provided on an outer circumferential surface of the second layer L2 that faces the atmosphere chamber 58. The cathode-side pump electrode 62 and the anode-side pump electrode 64 constitute a pump cell 88.

A pump voltage source 66 is adapted to apply a voltage between the pump electrodes 62, 64. With the voltage applied to the pump electrodes 62, 64, oxygen (O₂) contained in the exhaust gas within the cell chamber 52 contacts with the cathode-side pump electrode 62 and turns into oxygen ions. Also, when NOx contained in the exhaust gas contacts with the cathode-side pump electrode 62, a part of oxygen in the NOx turns into oxygen ions, and NOx is converted into NO. The oxygen ions thus produced flow in the second layer L2 toward the anode-side pump electrode 64. In this manner, oxygen contained in the exhaust gas within the cell chamber 52 moves in the second layer L2, and is thus pumped out to the outside. The amount of the oxygen thus pumped out to the outside increases as the voltage of the pump voltage source 66 increases. An ammeter 68 detects a current value A₁ that represents current flowing between the pump electrodes 62, 64.

At a location downstream of the pump cell 88, a cathode-side monitor electrode 70 is provided on an inner circumferential surface of the first layer L1 that faces the cell chamber 52. Also, an anode-side monitor electrode 72 is provided on an outer circumferential surface of the first layer L1 that faces the atmosphere chamber 56. The cathode-side monitor electrode 70 and the anode-side monitor electrode 72 constitute a monitor cell 90 for detecting remaining oxygen in the exhaust gas. A monitor voltage source 74 is adapted to apply a voltage between the monitor electrodes 70, 72.

While most of the oxygen in the exhaust gas is discharged by the pump cell 88, a slight amount of oxygen (on the order of ppm) still remains in the exhaust gas flowing in the neighborhood of the monitor cell 90. The monitor cell 90 detects the amount of the remaining oxygen. When a voltage is applied from the monitor voltage source 74 to between the monitor electrodes 70, 72, the remaining oxygen contacts with the cathode-side monitor electrode 70 and turns into oxygen ions. The oxygen ions then flow in the first layer L1 toward the anode-side monitor electrode 72. Thus, the amount of the remaining oxygen can be determined from a current value A₂ obtained by an ammeter 76 for detecting current flowing between the monitor electrodes 70, 72.

At a location downstream of the monitor cell 90, a cathode-side sensor electrode 78 is formed on the inner circumferential surface of the first layer L1 that faces the cell chamber 52. Also, an anode-side sensor electrode 80 is formed on the outer circumferential surface of the first layer L1 that faces the atmosphere chamber 56. The cathode-side sensor electrode 78 and the anode-side sensor electrode 80 constitute a sensor cell 92 for detecting the NOx concentration in the exhaust gas. The cathode-side sensor electrode 78 is formed of a material, such as rhodium (Rh) or platinum (Pt), which has a strong capability of reducing NO. The NO into which the NOx is converted by the pump cell 88 in the cell chamber 52 is decomposed into N₂ and O₂ at the cathode-side sensor electrode 78. As shown in FIG. 2, a certain voltage is applied from a sensor voltage source 86 to between the cathode-side sensor electrode 78 and the anode-side sensor electrode 80. With the voltage thus applied, the O₂ produced through decomposition at the cathode-side sensor electrode 78 turns into oxygen ions, which then move in the first layer L1 toward the anode-side sensor electrode 80. At this time, oxygen ions resulting from decomposition of NO and oxygen ions derived from the remaining oxygen in the exhaust gas are produced at the cathode-side sensor electrode 78, and a current proportional to the total amount of the oxygen ions flows between the cathode-side sensor electrode 78 and the anode-side sensor electrode 80.

Accordingly, the amount of oxygen produced through decomposition of NOx and the amount of the remaining oxygen are determined from a current value A₃ generated by an ammeter 84 for detecting current flowing between the sensor electrodes 78, 80. By subtracting the amount of the remaining oxygen detected by the monitor cell 90 from the detection value of the sensor cell 92, the amount of oxygen derived solely from NO can be determined.

The NOx in the exhaust gas is simply converted into NO in the vicinity of the pump cell 88 in the cell chamber 92, and the resulting NO is hardly reduced before reaching the sensor cell 90. Accordingly, the value obtained by subtracting the current value A₂ from the current value A₃ is proportional to the NOx concentration in the exhaust gas, and the NOx concentration in the exhaust gas can be accurately determined from the thus obtained value.

As described above, the NOx sensor 50 includes three sensor elements, namely, the pump cell 88, monitor cell 90 and the sensor cell 92. The basic arrangements of various types of sensors, such as an A/F sensor and a HC sensor, provided in the exhaust passage are similar to that of the NOx sensor 50 as shown in FIG. 2, though the number of cells may be different from one type of sensor to another.

As shown in FIG. 2, an electric heater 60 is provided below the atmosphere chamber 58. The NOx sensor 50, which performs its function when the temperature reaches 700° C.-800° C., is heated by the electric heater 60.

After the NOx sensor 50 reaches an appropriate operating temperature, the intensity of heating by the electric heater 60 is controlled in a feedback manner so that the resistance of the sensor element of the NOx sensor 50 is kept at a constant value. Since the sensor temperature and the resistance of the sensor element are in correlation with each other, the sensor element resistance can be controlled to a target value by feedback-controlling the intensity of heating by the electric heater 60 in accordance with the sensor element resistance, thus assuring desired characteristics of the NOx sensor 50. In this embodiment, the sensor element resistance of the NOx sensor 50 is detected each time a certain time (e.g., 256 msec) elapses, and the electric heater 60 is controlled in a feedback manner based on the detected sensor element resistance.

It is desirable to detect the sensor element resistance of the NOx sensor 50 in the pump cell 88 or the monitor cell 90. While current that depends upon the remaining oxygen and the amount of NO flows through the sensor cell 92 as described above, the current value obtained by the sensor cell 92 is an extremely small value on the order of nanoamperes (nA). On the other hand, a current on the order of milliamperes (mA) needs to pass through a cell for measurement of a resistance value in the cell. If a current on the order several times larger than that of the current flowing during detection of NOx is fed to the sensor cell 92, a problem due to an influence of noise, or the like, may subsequently occur to NOx detection. It is therefore desirable to detect the sensor element resistance in a cell other than the sensor cell 92 so as to accomplish the resistance detection without affecting NOx detection.

With regard to the monitor cell 90 that detects a slight amount of remaining oxygen, the current value A₂ obtained by the ammeter 76 is also on the order of nanoamperes (nA). Nevertheless, since variations in the amount of the oxygen remaining after discharge of oxygen by the pump cell 88 are relatively small, the frequency of detection of the remaining oxygen at the monitor cell 90 may be relatively low. Namely, the remaining oxygen may be detected by the monitor cell 90 at a relatively low frequency. Thus, even in the case where noise, or the like, occurs when a current on the order of milliamperes (mA) is fed to the monitor cell 90 so as to detect a resistance value, the timing of detection of the remaining oxygen may be delayed until an appropriate detection value can be obtained, and an influence of the noise, or the like, due to detection of the resistance value can be avoided. Thus, the monitor cell 90 is suitable for detection of the resistance value for use in feedback control of the electric heater 60. The pump cell 88, which is not used for obtaining a particular detection value, is also suitable for detection of the resistance value.

For the reasons as described above, it is desirable to detect the sensor element resistance in the pump cell 88 or the monitor cell 90 in order to obtain a resistance value for use in feedback control of the electric heater 60 without affecting the intended function (i.e., NOx detection) of the NOx sensor 50.

Next, a method of controlling the electric heater 60 in a feedback manner based on the sensor element resistance thus detected. In the present embodiment, the electric heater 60 is duty-controlled based on the detected sensor element resistance. In this control, the ECU 40 compares the detected sensor element resistance with a predetermined target value, and determines the duty ratio (heater control duty) of the energization time of the electric heater 60 (i.e., the time duration for which current is applied to the electric heater 60) through PID control, or the like.

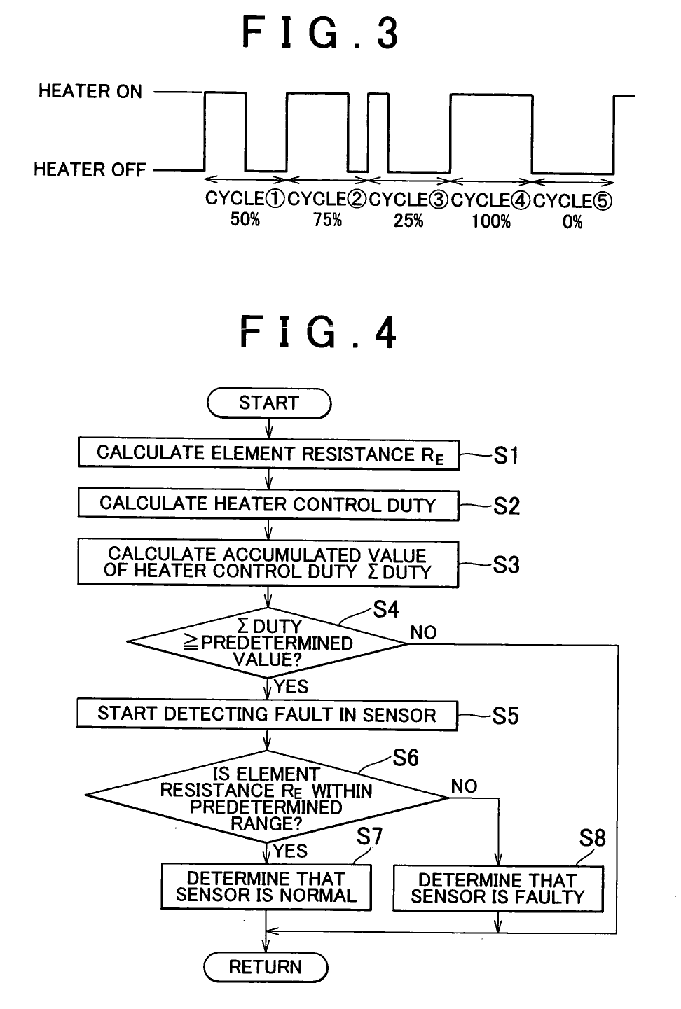

FIG. 3 is a schematic view illustrating examples of duty cycles determined by the ECU 40 for heater duty control. In FIG. 3, the time period of each of cycles (1)-(5) is identical, and the heater control duty is expressed as a percent that represents the ratio of the ON time to the entire period of each cycle (1)-(5). In feedback control of the electric heater 60, the ECU 40 generates a duty command signal representing a selected one of the cycles (1)-(5) based on the sensor element resistance, and the electric heater 60 is energized based on the duty command signal received from the ECU 40. The ECU 40 may also operate to directly energize the electric heater 60. Alternatively, a sensor control circuit (not shown) may be provided between the NOx sensor 50 and the ECU 40, and the electric heater 60 may be energized through the sensor control circuit.

In the cycle (1) of FIG. 3, the ON time and the OFF time are equal to each other, and the heater control duty is equal to 50%. In the cycle (2), the ON time is three-fourths of the entire period while the OFF time is one-fourth of the period, and thus the heater control duty is equal to 75%. Similarly, the heater control duty of the cycle (3) is equal to 25%, the heater control duty of the cycle (4) is equal to 100%, and the heater control duty of the cycle (5) is equal to 0%. The heater control duty is changed depending upon the sensor element resistance, so that the sensor element resistance is controlled to the target value. FIG. 3 illustrates some different examples of the heater control duty, from which an appropriate duty ratio is selected in actual control of the electric heater 60. When the electric heater 60 is started, for example, the heater control duty is set to 100% for a certain period of time. At a point in time when the NOx sensor 50 reaches an appropriate operating temperature, the heater control duty may be stepwise reduced from 100% to 80% and then from 80% to 60%.

Next, fault detection of the NOx sensor 50 by the fault detection system of the present embodiment will be described. In this embodiment, the heater control duty is controlled based on the sensor element resistance, and the fault detection control of the NOx sensor 50 is performed along with the duty control. The fault detection is performed based on the sensor element resistance under a condition that the temperature of the NOx sensor 50 has reached an appropriate operating temperature, since the sensor element resistance reaches a target value when the sensor is set to a certain temperature as described above.

The fault detection system of the present embodiment estimates the element temperature of the NOx sensor 50 based on an accumulated value of the heater control duty. As the heater control duty increases, the energization time of the electric heater 60 increases, resulting in an increase in the temperature of the NOx sensor 50. The accumulated value of the heater control duty in a given period of time corresponds to the energization time of the electric heater 60 within that period of time. Thus, it can be concluded whether the NOx sensor 50 has reached an appropriate temperature based on the accumulated value of the heater control duty.

In the example of FIG. 3, the accumulated value of the heater control duty from the cycle (1) to the cycle (5) is 250% (50+75+25+100+0=250(%)). The accumulated value is compared with a predetermined threshold value, and, if the accumulated value exceeds the predetermined threshold value, it is determined that the NOx sensor 50 has been sufficiently heated by the electric heater 60. The threshold value that is referred to for comparison is determined in advance from warm-up characteristics of the NOx sensor 50 obtained when it is warmed up by the electric heater 60.

As described above, in the present embodiment, it can be determined whether the temperature of the NOx sensor 50 has been raised to an appropriate operating temperature only by accumulating or summing the heater control duty determined by the ECU 40. Thus, the ECU 40 does not need to acquire information, such as a current value and a voltage value, from the NOx sensor 50, and does not require various calculations, such as computing of electric power. Consequently, the circuit configuration or arrangement and control algorithms associated with fault detection can be significantly simplified.

When the accumulated value of the heater control duty becomes equal to or larger than the predetermined threshold value, the sensor element resistance is detected, and it is determined whether the NOx sensor 50 is fault or operates abnormally, based on the detected element resistance. In the condition in which the accumulated value is equal to or larger than the predetermined value, it can be concluded that the NOx sensor 50 has been sufficiently heated to a temperature at which the sensor 50 operates normally to perform its function. Accordingly, if the sensor resistance value is within a predetermined range in this condition, it is determined that the NOx sensor 50 functions normally.

If the accumulated value of the heater control duty is equal to or larger than the predetermined value, and the sensor resistance value is not within the predetermined range, on the other hand, it can be concluded that the NOx sensor 50 itself is faulty, namely, an abnormality occurs in the NOx sensor 50 itself, or the NOx sensor 50 has not reached an appropriate temperature. In this case, therefore, it can be determined that a failure or abnormality occurs in the sensor element for which the resistance is detected, or in the electric heater 60.

Next, a control routine executed by the fault detection system of the present embodiment will be described with reference to the flowchart of FIG. 4. The following routine is executed at certain time intervals (e.g., 256 msec) after the ignition switch is turned ON. Initially, the sensor element resistance R_{E} of the NOx sensor 50 is calculated in step S1. In the next step S2, the heater control duty used for driving the electric heater 60 is calculated based on the element resistance R_{E}. In this step, the element resistance R_{E} obtained in step S1 is compared with a target value, and an appropriate heater control duty is determined by a suitable method, such as PID control. In the next step S3, an accumulated value (ΣDUTY) of the heater control duty that has been determined up to this point in time is calculated.

In step S4. the accumulated value of the heater control duty is compared with a predetermined value. Here, the predetermined value used for the comparison is determined in advance based on, for example, warm-up characteristics of the sensor.

If it is determined in step S4 that the accumulated value of the heater control duty is equal to or larger than the predetermined value, the control process proceeds to step S5 to start detecting a fault in the NOx sensor 50. If it is determined in step S4 that the accumulated value of the heater control duty is smaller than the predetermined value, it is judged that the sensor element has not sufficiently heated by the electric heater 60, and the control process return to step S1 without effecting fault detection.

After execution of step S5, it is determined in step S6 whether the element resistance R_{E} detected in step S1 is within a predetermined range. If the element resistance R_{E} is within the predetermined range, the control process proceeds to step S7 to determine that the sensor element of the NOx sensor 50 operates normally.

If the element resistance R_{E} is not within the predetermined range, on the other hand, the control process proceeds to step S8 to determine that a fault or abnormality occurs in the sensor element of the NOx sensor 50 itself or in the electric heater 60. In this case, the ECU 40 performs an operation to indicate the occurrence of the fault by, for example, setting a fault flag to ON, and takes a fail-safe measure of, for example, inhibiting energization of the electric heater 60 or inhibiting the use of the sensor output.

In the flowchart of FIG. 4, the element resistance R_{E} is constantly detected for feedback-control of the electric heater 60. However, in the case where the heater control duty is set in advance to a fixed value during starting, for example, the element resistance R_{E} may not be detected until the accumulated value of the heater control duty becomes equal to or larger than a predetermined value, and fault determination may be performed by detecting the element resistance R_{E} when the accumulated value becomes equal to or larger than the predetermined value.

While the heating condition of the electric heater 60 is estimated based on the accumulated value of the heater control duty in the method as described above, the accumulated value may be calculated by using values obtained by multiplying the heater control duty by a certain coefficient. This method is effective and advantageous in the case where computing using the heater control duty as it is involves processing of large numerical values. Also, the heating condition may be estimated from an accumulated value of the ON time of the electric heater 60, instead of the heater control duty. This method is effective and advantageous when the electric heater 60 is controlled in terms of the ON time. Thus, the temperature of the sensor element may be estimated by calculating an accumulated value of a characteristic value other than the heater control duty, provided that the characteristic value is equivalent to or corresponds to the energization time of the electric heater 60.

While the NOx sensor 50 is employed as a sensor on which fault detection is performed in the illustrated embodiment, the invention may be equally applied to fault detection of other sensors, such as an A/F sensor and a HC sensor, disposed in the exhaust passage. Also, the invention may be equally applied to fault detection of sensors other than the sensors disposed in the exhaust passage.

In the embodiment as described above, the heated condition of the sensor element is determined based on the accumulated value of the heater control duty, namely, the heated condition can be determined solely on the heater control duty set by the ECU 40. Accordingly, there is no need to acquire information, such as a voltage applied to the sensor and a current passing through the sensor, other than the heater control duty, thus eliminating a need for processing, such as computing of electric power based on the voltage value and the current value. Consequently, the control circuit of the NOx sensor 50 can be simplified, and the control logic can also be simplified.

What is claimed is:

1. A fault detection system for detecting a fault in a sensor based on a resistance of a sensor element, comprising:
a detector that detects the resistance of the sensor element;
a heating device that heats the sensor element; and
a controller that:
calculates an accumulated value of energization time of the heating device or an accumulated value of a characteristic value corresponding to the energization time of the heating device; and
detects a fault in the sensor based on the resistance of the sensor element and the accumulated value.

2. The fault detection system according to claim 1, wherein the controller compares the accumulated value with a predetermined value, and determines whether the sensor is faulty based on the resistance of the sensor element when the accumulated value becomes equal to or larger than the predetermined value.

3. The fault detection system according to claim 1, wherein the controller determines whether the sensor element or the heating device is faulty, based on the resistance of the sensor element and the accumulated value.

4. The fault detection system according to claim 1, wherein the controller acquires a duty value representing the energization time of the heating device, as the characteristic value, and calculates the accumulated value of the duty value.

5. The fault detection system according to claim 4, wherein the controller determines whether the sensor element or the heating device is faulty, based on the resistance of the sensor element and the accumulated value.

6. The fault detection system according to claim 4, wherein the controller compares the accumulated value with a predetermined value, and determines whether the sensor is faulty based on the resistance of the sensor element when the accumulated value becomes equal to or larger than the predetermined value.

7. The fault detection system according to claim 6, wherein the controller determines whether the sensor element or the heating device is faulty, based on the resistance of the sensor element and the accumulated value.

8. A method of detecting a fault in a sensor based on a resistance of a sensor element, comprising the steps of:
detecting the resistance of the sensor element;
energizing a heating device to heat the sensor element; and
calculating an accumulated value of energization time of the heating device or an accumulated value of a characteristic value corresponding to the energization time of the heating device; and
detecting a fault in the sensor based on the resistance of the sensor element and the accumulated value.

9. The method according to claim 8, wherein the accumulated value is compared with a predetermined value, and it is determined whether the sensor is faulty based on the resistance of the sensor element when the accumulated value becomes equal to or larger than the predetermined value.

10. The method according to claim 8, wherein it is determined whether the sensor element or the heating device is faulty, based on the resistance of the sensor element and the accumulated value.

11. The method according to claim 8, wherein a duty value representing the energization time of the heating device is acquired as the characteristic value, and the accumulated value of the duty value is calculated.

12. The method according to claim 11, wherein it is determined whether the sensor element or the heating device is faulty, based on the resistance of the sensor element and the accumulated value.

13. The method according to claim 11, the accumulated value is compared with a predetermined value, and it is determined whether the sensor is faulty based on the resistance of the sensor element when the accumulated value becomes equal to or larger than the predetermined value.

14. The method according to claim 13, wherein it is determined whether the sensor element or the heating device is faulty, based on the resistance of the sensor element and the accumulated value.
